(19) United States
(12) Patent Application Publication
(10) Pub. No.: US 2023/0201987 A1
(43) Pub. Date: Jun. 29, 2023

(54) MOVABLE TABLE ASSEMBLY FOR A MACHINE TOOL OF LARGE DIMENSIONS

(71) Applicant: INNSE-BERARDI S.P.A. SOCIETA' UNIPERSONALE, Brescia (IT)

(72) Inventors: Roberto CODINI, Brescia (IT); Giovanni ZANATTA, Brescia (IT)

(21) Appl. No.: 17/928,350

(22) PCT Filed: May 14, 2021
(86) PCT No.: PCT/IB2021/054138

§ 371 Date: Nov. 29, 2022

(30) Foreign Application Priority Data
Jul. 16, 2020 (IT) 102020000017305

(51) Int. Cl. B23Q 16/10; B23Q 5/12

(52) U.S. Cl. CPC B23Q 16/10; B23Q 5/12

(57) ABSTRACT

A table assembly for a machine tool is provided. The table assembly has a slide, a rotatable table and a table rotation mechanism placed on board the slide and adapted to be driven to rotate the table about a vertical axis. The table rotation mechanism has at least one rotation assembly engaged with a ring gear of the table. The at least one rotation assembly has a torque motor having a vertical motor axis and a reduction gear having an inlet engaged with the torque motor, and an outlet pinion engaged with the ring gear of the table, coaxial to the motor axis. The machine tool is a milling machine or a gantry boring machine.

### CROSS-REFERENCE TO RELATED APPLICATIONS

This application is a National Phase Application of PCT International Application No. PCT/IB2021/054138, having an International Filing Date of May 14, 2021 which claims priority to Italian Application No. 102020000017305 filed Jul. 16, 2020, each of which is hereby incorporated by reference in its entirety.

### FIELD OF THE INVENTION

The present invention belongs to the field of machine tools; in particular, the present invention relates to a movable table assembly for a machine tool of large dimensions, such as a milling machine or a gantry boring machine.

### BACKGROUND OF THE INVENTION

Such machines are usually intended for mechanical processing operations on very bulky and heavy semi-finished products, such as reactor casings for the chemical or nuclear industry, ship masts, and the like. For this reason, even if the dimensions of the machines themselves are considerable (for example, the Applicant manufactures and markets the gantry milling machine referred to as ATLAS, provided with a bench up to 30 meters long), it is highly important to limit the dimensions of some accessory assemblies, so that they do not interfere with the movement operations of the semi-finished products to be processed or with the processing operations themselves.

### SUMMARY OF THE INVENTION

It is the object of the present invention to provide a movable table assembly for a machine tool of large dimensions, such as a milling machine, a lathe, or a gantry boring machine, for which the overall dimensions of the motor assembly, intended for rotationally driving the table, are highly small, while maintaining the performance unchanged.

Such an object is achieved by a table assembly as described and claimed herein. Advantageous embodiments of the table assembly of the present invention are also described.

### BRIEF DESCRIPTION OF THE FIGURES

The features and advantages of the table assembly according to the present invention will become apparent from the following description, given by way of non-limiting example, in accordance with the accompanying drawings, in which:

FIG. 1 shows a machine tool according to an embodiment of the present invention;

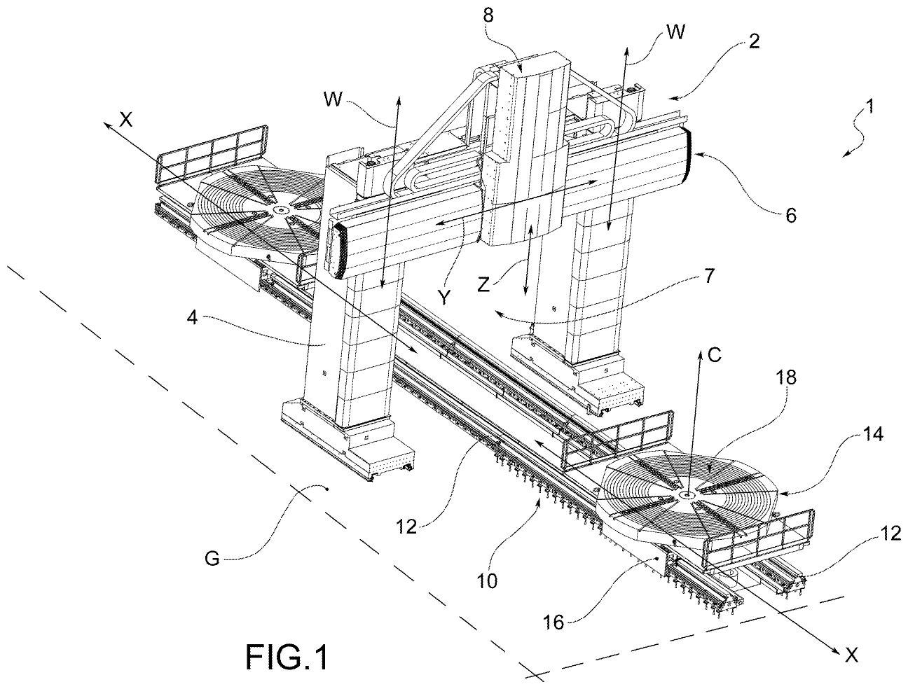

FIG. 2 depicts a table assembly (without table) according to an embodiment of the present invention, supported by benches;

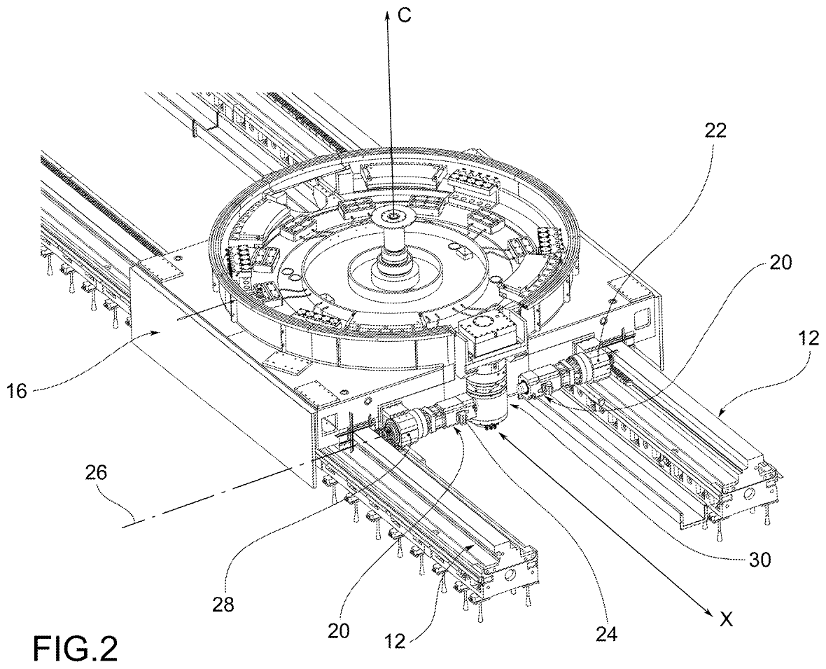

FIG. 3 depicts a sectional view of a table assembly according to an embodiment of the present invention, supported by benches; and

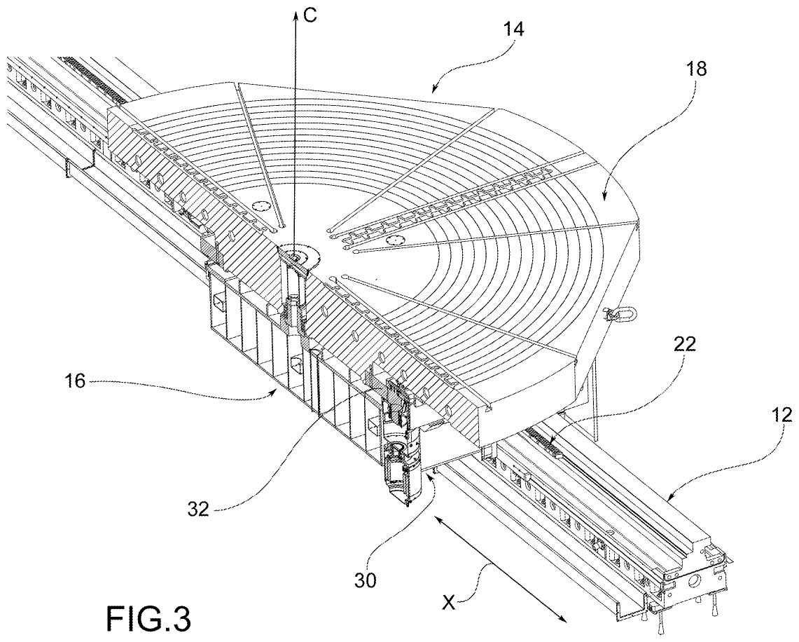

FIG. 4 is an enlargement of a detail of FIG. 3 which highlights a rotation assembly of the table assembly.

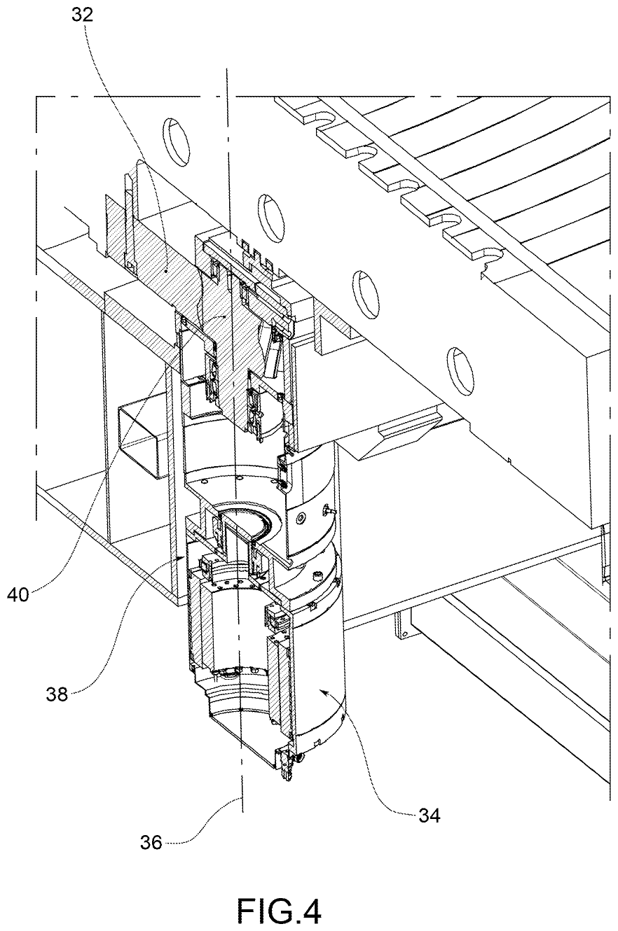

### DETAILED DESCRIPTION

For clarity of presentation, reference will be made hereinafter to a gantry milling machine; however, the invention is feasible on any other machine tool of large dimensions, for example a boring machine or a lathe.

In the figures of the accompanying drawings, 1 indicates a machine tool of large dimensions as a whole, for example a gantry milling machine, resting on a ground plane G. The machine tool 1 comprises, for example, a gantry structure 2 comprising a pair of vertical uprights 4 and a crosspiece 6 supported by the uprights 4; the pair of uprights 4 and the crosspiece 6 delimit an opening 7 of the gantry structure 2.

The crosspiece 6 is translatable on command along the uprights 4, along a vertical axis W. The machine tool 1 further comprises a cart 8, supported by the crosspiece 6, which is translatable on command along the crosspiece 6, along a 30 transverse axis Y. The machine tool 1 finally comprises a ram (not shown), supported by the cart 8, which is translatable along a further vertical axis Z, carrying a rotating spindle, to which a tool can be applied in order to perform chip removal processing operations.

The machine tool 1 further comprises a support apparatus 10, constrained to the ground plane G, having an extension along a longitudinal direction X, for example such as to cross the opening 7 of the gantry structure 2.

In the example shown, the uprights 4 are fixed, i.e., they are constrained to the ground plane G; according to a further embodiment, the uprights are movable on command parallel to the longitudinal direction X.

The support apparatus 10 comprises a pair of benches 12, each of which 10 extends mainly along the longitudinal axis X and is transversely spaced apart from the other, and at least one table assembly 14 for supporting the semi-finished product to be processed.

An embodiment of such a support apparatus is shown in Italian patent no. 1413392 to the Applicant, the teaching of which on the construction of such an apparatus is explicitly incorporated herein.

According to an embodiment, the machine tool 1 comprises two table assemblies 14, one arranged on one side and the other on the other side of the gantry structure 2.

The table assembly 14 comprises a slide 16 supported by the benches 12 and translatable on command along the benches 12, along a longitudinal axis X, and a table 18 supported by the slide 16 and rotatable with respect to a vertical axis C.

The table assembly 14 further comprises a slide translation mechanism adapted to be driven to translate the slide 16 along the benches 12.

According to a preferred embodiment, the slide translation mechanism comprises at least one gearmotor assembly 20 on board the slide 16, engaged with a rack 22 fixed to the respective bench 12.

For example, the gearmotor assembly 20 is arranged between the two benches 12 and comprises a motor 24, having a motor axis 26 orthogonal to the longitudinal axis X and to the vertical axis C, and a reduction gear 28 having an inlet, engaged with the motor 24, and an outlet, engaged with the rack 22, coaxial to the motor axis 26.

Preferably, the slide translation mechanism comprises at least two gearmotor assemblies 20, for example arranged on the same side of the slide 16. Said gearmotor assemblies 20 are arranged so that the respective motors 24 are transversely spaced.

Preferably, the slide translation mechanism comprises two pairs of gearmotor assemblies 20, each pair being arranged on one side of the slide 16, so that the motors are driven in opposition, to eliminate the clearances between the outlet pinion of the respective gearmotor and the rack (Twin-Drive).

The table assembly 14 further comprises a table rotation mechanism adapted to be driven to rotate the table 18 about the vertical axis C.

The table rotation mechanism comprises at least one rotation assembly 30 on 10 board the slide 16, engaged with a ring gear 32 of the table 18.

The rotation assembly 30 comprises a torque motor 34 having a vertical motor axis 36, i.e., parallel to the vertical axis C, and a reduction gear 38, preferably epicyclic, having an inlet, engaged with the torque motor 34, and an outlet pinion 40, engaged with the ring gear 32 of the table 18, coaxial to the motor axis 36.

In particular, the epicyclic reduction gear comprises a sun gear, planetary gears, a planetary carrier, and a ring gear for reduction gear; the sun gear is rotatable and engaged with the motor axis 36 of the torque motor 34, the ring gear for reduction gear is fixed, the planetary gears roll on the sun gear and on the ring gear for reduction gear, and the planetary carrier is engaged with the outlet pinion 40.

Preferably, the outlet pinion 40 meshes directly with the ring gear 32 of the table 18. According to an alternative embodiment, at least one idle gear is placed between the outlet pinion 40 and the ring gear 32.

Preferably, the rotation assembly 30 is arranged between the two benches 12; for example, the rotation assembly 30 is arranged between two gearmotor assemblies 20 of the slide translation mechanism.

Preferably, the table rotation mechanism comprises at least two rotation assemblies 30, each rotation assembly 30 being arranged on a side of the slide 16. In this variant, when the table 18 must provide a continuous rotation, generally at high speed, for performing turning or boring operations, the two torque motors are driven in concert; on the other hand, when the table 18 must provide a positioning rotation, for example in milling operations, the two torque motors are driven in opposition, to eliminate the clearances between the outlet pinion of the respective reduction gear and the ring gear of the table (Twin-Drive).

Innovatively, the table assembly according to the present invention meets the needs of the field, since it allows to minimize the overall dimensions of the motors required for the rotation of the table.

In particular, according to an advantageous aspect, the combination of the torque motor and the reduction gear allows to exploit the compact dimensions of the torque motor and the high speeds which can be reached with the reduction gear.

It is apparent that, in order to meet contingent needs, those skilled in the art may make changes to the table assembly described above, all contained within the scope of protection as described and claimed herein.

1. A table assembly for a machine tool, optionally the machine tool being a milling machine or a gantry boring machine, the table assembly comprising a slide translatable on command along a longitudinal axis (X), a table supported by the slide and rotatable with respect to a vertical axis (C), and a table rotation mechanism placed on board the slide and adapted to be driven to rotate the table about the vertical axis (C), wherein the table rotation mechanism comprises at least one rotation assembly engaged with a ring gear of the table and comprising a torque motor having a vertical motor axis and a reduction gear having an inlet, engaged with the torque motor, and an outlet pinion, engaged with the ring gear of the table, coaxial to the motor axis.

2. The table assembly of claim 1, wherein the reduction gear of the at least one rotation assembly is an epicyclic reduction gear.

3. The table assembly of claim 2, wherein the epicyclic reduction gear comprises a sun gear, planetary gears, a planetary carrier and a ring gear for reduction gear, and wherein the sun gear is rotatable and engaged with the motor axis of the torque motor, the ring gear for reduction gear is fixed, the planetary gears roll on the sun gear and on the ring gear for reduction gear, and the planetary carrier is engaged with the outlet pinion.

4. The table assembly of claim 1, wherein the outlet pinion meshes directly with the ring gear of the table.

5. The table assembly of claims 1 wherein the at least one rotation assembly comprises an idle gear for transmitting motion between the outlet pinion and the ring gear.

6. The table assembly of claim 1, wherein the table rotation mechanism comprises two rotation assemblies, each rotation assembly of the two rotation assemblies being arranged on a respective side of the slide.

7. The table assembly of claim 6, wherein two torque motors of the two rotation assemblies are configured to be driven in concert.

8. The table assembly of claim 6, wherein two torque motors of the two rotation assemblies are configured to be driven in opposition.

9. The table assembly of claim 1, further comprising a slide translation mechanism placed on board the slide and adapted to be driven to translate the slide along the longitudinal axis (X).

10. The table assembly of claim 9, wherein the slide translation mechanism comprises at least one gearmotor assembly.

11. The table assembly of claim 10, wherein the at least one gearmotor assembly comprises a motor, having a motor axis orthogonal to the longitudinal axis (X) and the vertical axis (C), and a reduction gear having an inlet, engaged with the motor, and an outlet, engageable with a rack, coaxial to the motor axis.

12. The table assembly of claim 10, wherein the slide translation mechanism comprises two gearmotor assemblies arranged on a same side of the slide.

13. The table assembly of claim 12, wherein the rotation assembly is arranged between said two gearmotor assemblies.

14. The table assembly of claim 10, wherein the slide translation mechanism comprises two gearmotor assemblies, each gearmotor assembly being arranged on a respective side of the slide.

15. The table assembly of claim 14, wherein two motors of the two gearmotor assemblies are configured to be driven in opposition.

16. A support apparatus for a machine tool comprising:
at least one table assembly comprising a slide translatable on command along a longitudinal axis (X), a table supported by the slide and rotatable with respect to a vertical axis (C), and a table rotation mechanism placed on board the slide and adapted to be driven to rotate the table about the vertical axis (C), wherein the table rotation mechanism comprises at least one rotation assembly engaged with a ring gear of the table and comprising a torque motor having a vertical motor axis and a reduction gear having an inlet engaged with the torque motor, and an outlet pinion engaged with the ring gear of the table, coaxial to the motor axis; and
a pair of benches supporting the at least one table assembly, wherein each bench of the pair of benches has a main extension along the longitudinal axis (X) and is transversely spaced apart from the other.

17. The support apparatus of claim 16, comprising two table assemblies.

18. The support apparatus of claim 16, wherein the at least one rotation assembly is arranged between said pair of benches.

19. The support apparatus of claims 16, wherein the at least one table assembly further comprises a slide translation mechanism placed on board the slide and adapted to be driven to translate the slide along the longitudinal axis (X), and wherein the slide translation mechanism comprises at least one gearmotor assembly and the at least one gearmotor assembly is arranged between said pair of benches.

20. A machine tool comprising:
a support apparatus according to claim 16; and
a gantry structure supporting a cart.

21. The machine tool of claim 20, wherein the machine tool is a milling machine, a boring machine or a lathe.
